(19) United States
(12) Patent Application Publication
(10) Pub. No.: US 2008/0071396 A1
(43) Pub. Date: Mar. 20, 2008

(54) COMPUTERIZED SYSTEMS AND METHODS FOR HAZARDOUS MATERIAL RELEASE EVENT RESPONSE

(75) Inventors: Charles H. Quandel, Chicago, IL (US); Douglas Wayne Morrison, Cameron, MO (US); Jeffrey L. Siegel, Chicago, IL (US); W. Robert Moore, Naperville, IL (US); Glen Arthur Herman, Olathe, KS (US); Alex Kavanagh, Chicago, IL (US); Jason Thomas Daihl, Tinley Park, IL (US); Robert J. Marros, Chicago, IL (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: HNTB HOLDINGS LTD, Kansas City, MO (US)

(21) Appl. No.: 11/530,888

(22) Filed: Sep. 11, 2006

Related U.S. Application Data
(60) Provisional application No. 60/822,635, filed on Aug. 16, 2006.

(51) Int. Cl. G05B 13/02

(52) U.S. Cl. 700/49

(57) ABSTRACT

Tools are provided for allowing ready access to information relevant to events associated with the release of hazardous materials. The tools also facilitate characterization of the events and determination of appropriate emergency responses for the events. When an indication of a hazardous material release event is received, data including information associated with the transportation of hazardous materials may be accessed to characterize the hazardous material release event. Based on the characterized hazardous material release event, appropriate responses are determined that are tailored the specifics of the hazardous material release event.

### CROSS-REFERENCE TO RELATED APPLICATIONS

This application claims the benefit of U.S. Provisional Application No. 60/822,635, filed Aug. 16, 2006.

### STATEMENT REGARDING FEDERALLY SPONSORED RESEARCH OR DEVELOPMENT

Not applicable.

### TECHNICAL FIELD

Embodiments of the present invention relate to facilitating responses to the release of hazardous materials. More particularly, embodiments relate to computerized systems and methods that provide detailed information associated with the transportation of hazardous materials and other context-sensitive information to facilitate the characterization of hazardous material release events and appropriately tailor emergency responses to the hazardous material release events.

### BACKGROUND

Hazardous materials are substances that, if released, pose a risk to life, health, and/or property due to their chemical, biological, and/or physical nature. Toxic inhalation hazard (TIH) chemicals are particularly dangerous types of hazardous materials because, if released, TIH chemicals may quickly spread to a surrounding area and cause harm to individuals who inhale the chemicals.

Billions of tons of hazardous materials, including TIH chemicals, are shipped throughout the United States annually by various modes of transportation, including, for example, truck, rail, pipeline, and water modes. Oftentimes, the transport of such hazardous materials is through dense urban environments. The movement of hazardous materials through densely populated areas presents a significant safety risk to the surrounding population. For instance, accidents, such as traffic accidents for trucks or train derailments, may result in the release of hazardous materials being transported. Additionally, natural disasters, such as earthquakes, tornados, and hurricanes, may result in the release of hazardous materials. Further, in the wake of the September 11^{th} terrorist attacks on the United States, there is an increased concern regarding the opportunity for terrorists to target the movement of hazardous materials through dense urban environments.

Despite significant efforts to prevent events associated with the release of hazardous materials, such release events occasionally occur. Currently, when a hazardous material release event occurs, emergency response personnel are tasked with responding to the event. In order to save lives and mitigate the deleterious effects of a release of hazardous materials, event response actions must be taken quickly. However, emergency response personnel typically do not have ready access to the information necessary to determine an appropriate response. For instance, in the case of a release from a train car, emergency response personnel may first need to determine who owns the track and/or train. Using that information, emergency response personnel may need to manually contact the owner of the track and/or train to determine what hazardous materials were being carried by the train. This may entail a slow and time-consuming process that delays a prompt response.

A variety of additional information may also be pertinent to appropriately characterizing and tailoring an event response. This information may be dispersed among a variety of different sources, which emergency personnel must scramble to contact. This may also be a slow and time-consuming process, thereby delaying any event response and endangering the safety and lives of individuals located adjacent to a release of hazardous materials. Additionally, this manual process may be error-prone due to miscommunications that may occur as information is communicated from one party to another.

In some cases, emergency personnel may attempt to respond to a release of hazardous materials without first acquiring information necessary to tailor an appropriate response, potentially leading to unfortunate results. At best, the response may be compromised and hampered. In some instances, however, emergency personnel may be placed at risk, injured, or even killed. For instance, without the appropriate information, emergency personnel may not have necessary personal protective gear when responding to an event.

Accordingly, there is a need for systems and methods for efficiently collecting information necessary to characterize a hazardous material release event and to determine appropriate event response actions based on the characterized event.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to systems, methods, and user interfaces for providing ready access to information relevant to hazardous material release events, characterizing hazardous material release events, and determining appropriate responses to hazardous material release events. Accordingly, in one aspect, an embodiment of the present invention is directed to a computerized method for facilitating a response to an event involving a release of one or more hazardous materials. The method includes receiving an indication of a hazardous material release event. The indication includes information associated with a location of the hazardous material release event. The method also includes characterizing the hazardous material release event by comparing the information associated with the location of the hazardous material release event with information associated with the transportation of hazardous materials. The method further includes determining an event response based on the characterized hazardous material release event. The method still further includes presenting information associated with the event response to a user.

In another aspect, an embodiment of the present invention relates to a computerized system for a facilitating response to an event associated with a release of one or more hazardous materials. The computerized system includes one or more computing devices having one or more computer-readable media with computer-program modules embodied thereon. The computer-program modules include a release event characterization module and an event response determining module. The release event characterization module characterizes an event associated with the release of one or more hazardous materials. The event response determining module determines an event response based on the characterized event.

In a further aspect of the present invention, an embodiment relates to one or more computer-readable media having computer-useable instructions embodied thereon, wherein the computer-useable instructions are for performing a method for facilitating a response to an event associated with a release of one or more hazardous materials. The method includes receiving an indication of a hazardous material release event. The method also includes characterizing the hazardous material release event. The method further includes determining an event response based on the characterized hazardous material release event. The method still further includes presenting information associated with the event response to a user.

### BRIEF DESCRIPTION OF THE SEVERAL VIEWS OF THE DRAWING

Illustrative embodiments of the present invention are described in detail below with reference to the attached drawing figures, wherein:

FIG. 1 is a block diagram showing an exemplary system that may be employed for aggregating information to permit characterizing hazardous material release events in accordance with an embodiment of the present invention;

FIG. 2 is a block diagram showing an exemplary system that may be employed to characterize a hazardous material release event and determine an appropriate response to the hazardous material release event in accordance with an embodiment of the present invention; and

FIG. 3 is a flow diagram showing an exemplary method for characterizing a hazardous material release event and determining an appropriate response to the hazardous material release event in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of the methods employed, the terms should not be interpreted as implying any particular order among or between various steps herein disclosed unless and except when the order of individual steps is explicitly described.

Embodiments of the present invention relate to providing tools to assist in the response to releases of hazardous materials. In particular, embodiments provide computerized systems and methods for efficiently characterizing hazardous material release events and determining appropriate responses. As used herein, the term “hazardous material” includes substances that, if released, pose a risk to life, health, and/or property due to their chemical, biological, and/or physical nature. Additionally, as used herein, the term “hazardous material release event” includes any type of event in which a hazardous material has been released, including, for example, accidents, natural disasters, and/or terrorist activity.

In one aspect, embodiments of the present invention provide a system that aggregates or otherwise provides ready access to information allowing for the efficient characterization of hazardous material release events and determination of proper responses. By way of example only and not limitation, such information may include information associated with the transportation of hazardous materials, including, for instance, type and volume of hazardous material, place of origination, place of destination, route, and location information. Additionally, the system may include context-sensitive information along linear corridors through which hazardous materials are transported and surrounding areas, further facilitating the characterization of hazardous material release events and determination of appropriate responses. Information may be collected from a variety of different sources, including both governmental and commercial sources, in various embodiments of the present invention.

Embodiments of the present invention further include a system allowing users to access the aggregated information. For instance, when responding to a hazardous material release event, emergency response personnel may employ the system to readily access information necessary to respond in a quick and safe manner. The system may automatically characterize the hazardous material release event based on an indication of an event, such as, for example, a location for the event, and provide characterization information to a user. The system may further employ a knowledge base containing information associated with response procedures in conjunction with characterization information to automatically determine recommended emergency response procedures for a particular release event. Recommended emergency response procedures may include, for instance, areas to evacuate, evacuation routing, corridors to shut down, emergency personnel routing, and emergency equipment, as well as a variety of other emergency response recommendations.

Some embodiments of the present invention may be implemented at least in part in a variety of computing system environments. For example, embodiments may be implemented in an application program running on one or more personal computers (PCs). This computing system environment is only one example of a suitable computing environment and is not intended to suggest any limitation as to the scope of use or functionality of the invention. Embodiments of the invention may also be implemented with numerous other general purpose or special purpose computing system environments or configurations. Examples of other well-known computing systems, environments, and/or configurations that may be suitable for use with the invention include, but are not limited to, server computers, hand-held or laptop devices, multiprocessor systems, microprocessor-based systems, programmable consumer electronics, network PCs, minicomputers, mainframe computers, distributed computing environments that include any of the above systems or devices, and the like.

Embodiments of the invention may be described in the general context of computer-executable instructions, such as program modules. Generally, program modules include routines, programs, objects, components, segments, schemas, data structures, etc. that perform particular tasks or implement particular abstract data types. Embodiments of the invention may also be practiced in distributed computing environments where tasks are performed by remote processing devices that are linked through a communications network. In a distributed computing environment, program modules may be located in both local and remote computer storage media including memory storage devices.

Computers typically include a variety of computer-readable media. Computer-readable media includes any media that can be accessed by a computer and includes both volatile and nonvolatile media, removable and non-removable media. By way of example, and not limitation, computer-readable media may comprise computer storage media and communications media. Computer storage media include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD), holographic or other optical storage, magnetic cassettes, magnetic tape, magnetic disk storage or other magnetic storage devices, or any other medium which can be used to store the desired information and which can be accessed by a computer.

Communications media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communications media includes wired media such as a wired network or direct wired connection, and wireless media such as acoustic, RF, infrared, spread spectrum and other wireless media. Communications media are commonly used to upload and download information in a network environment, such as the Internet. Combinations of any of the above should also be included within the scope of computer-readable media.

The computer may operate in a networked environment using logical connections to one or more remote computers, such as a personal computer, a server, a router, a network PC, a peer device or other common network node, and typically includes many or all of the elements described above. The logical connections may include connections to a local area network (LAN), a wide area network (WAN) and/or other networks. Such networking environments are commonplace in offices, enterprise-wide computer networks, intranets and the Internet.

Computer storage mechanisms and associated media provide storage of computer-readable instructions, data structures, program modules and other data for the computer. A user may enter commands and information into the computer through input devices such as a keyboard and pointing device, commonly referred to as a mouse, trackball or touch pad. Other input devices may include a microphone, touchscreen, camera, joystick, game pad, scanner, or the like. In addition to a monitor or other type of display device, computers may also include other peripheral output devices such as speakers and printers, which may be connected through an output peripheral interface.

Although many other internal components of computers have not been discussed herein, those of ordinary skill in the art will appreciate that such components and their interconnection are well-known. Accordingly, additional details concerning the internal construction of computers need not be disclosed in connection with the present invention.

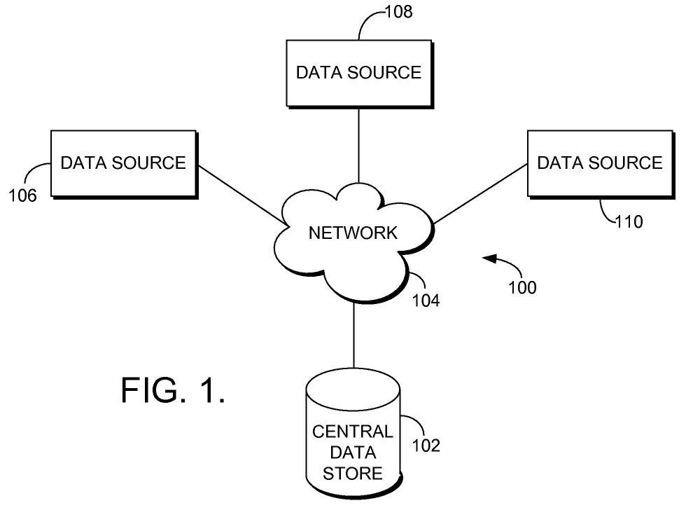

As indicated previously, one aspect of the present invention is directed to providing efficient access to information relevant to the identification and characterization of hazardous material release events. Accordingly, information may be readily available to users as needed when hazardous material release events occur. Referring to FIG. 1, a block diagram is provided illustrating an exemplary tracking system 100 for providing access to information that allows for the identification and characterization of hazardous material release events and facilitates the determination of emergency response in accordance with an embodiment of the present invention.

As shown in FIG. 1, the tracking system 100 generally provides a central data store 102 for facilitating access to information from a variety of data sources, such as the data sources 106, 108, 110. The central data store 102 may store or otherwise provide access to data relevant to characterizing hazardous material release events and determining appropriate responses. The data may include detailed information associated with hazardous material shipments. For each shipment, the central data store 102 may store information such as, for instance, the type of hazardous material being shipped, the volume of hazardous material, the place of origination, the place of destination, route, estimated time of departure, actual time of departure, as well as other types of information associated with the transportation of hazardous materials.

Additionally, the central data store 102 may store or otherwise provide access to information associated with the location of shipments. Location information for shipments may be associated with other information for each respective shipment. In some embodiments, the location information may be real-time or near real-time information from location tracking systems. For example, transports, such as rail cars or trucks, may be equipped with GPS devices that allow the current location of the transports to be tracked. As another example, a radio-frequency (RF) system may be employed and an RFID placed on transports to track location. In other embodiments, the location information may be estimated based on available information, such as, for instance, the place of origination, route, and departure time for a shipment.

The central data store 102 may further include or otherwise provide access to a variety of context-sensitive information. The context-sensitive information may include maps, GIS information, survey data, imagery, and other information associated with linear corridors through which hazardous materials may be transported. In some embodiments, the information may include real-time data, such as current weather information. By including such context-sensitive information, hazardous material release events may be evaluated in the context of the location in which they occur, taking into consideration information such as adjacent populations and infrastructure.

Although only a single central data store 102 is shown in FIG. 1, in various embodiments of the present invention one or more data stores may be used to store or otherwise provide access to information allowing for the characterization of a hazardous material release event and facilitating responses. Additionally, in various embodiments of the present invention, the geographical extent for which information is available via one or more associated data stores may vary. For instance, in some embodiments, the central data store 102 may include or otherwise provide access to information associated with the transportation of hazardous materials over a wide geographical area, such as a country or a continent. In other embodiments, the central data store 102 may include or otherwise provide access to information associated with the transportation of hazardous material for a local area, such as a city, for example.

As depicted in FIG. 1, information relevant to the characterization of hazardous material events and determination of appropriate event responses may be accessed from a variety of data sources, such as the data sources 106, 108, 110. One skilled in the art will appreciate that three data sources are shown in FIG. 1 for illustrative purposes only and that any number of data sources may be provided within the scope of the present invention. The data sources 106, 108, 110 may include servers, data stores, and other types of computing devices in communication with the central data store 102 via the network 104. The network 104 may include one or more wide area networks (WANs) and/or one or more local area networks (LANs), as well as one or more public networks, such as the Internet, and/or one or more private networks. Data may be communicated among the central data store 102 and the data sources 106, 108, 110 in a variety of different manners within the scope of the present invention. For instance, in some cases, data may be automatically communicated to the central data store 102 by pulling the data from a data source or by receiving data pushed from a data source. In other embodiments, a user may employ a data source to access the central data store 102 and manually provide information for storage by the central data store 102. In further embodiments, the central data store 102 may not store actual data, but may instead facilitate access to data stored at a data source. One skilled in the art will recognize that a variety of other approaches may be employed to communicate data among components within the system 100. Any and all such variations are contemplated within the scope of the present invention.

The actual sources of information may vary widely and may include both governmental, commercial, and/or private sources. For instance, transportation information may be obtained from carriers, which typically record information associated with the transportation of hazardous materials in documents such as waybills, manifests, and bills of lading. In some cases, carriers may maintain computing systems to organize and store this information. In such instances, the carrier computing systems may be configured to communicate with the central data store 102, such that information may be automatically transferred from the carrier computing system to the central data store 102. With respect to location information, a data source may be a location tracking system, such as a GPS system or RF system employing RFIDs. Context-sensitive information may be accessed from any of a variety of different sources, such as existing public and commercially available GIS data resources, meteorological data sources, and survey data sources. In an embodiment, the central data store 102 includes or is otherwise interfaced with the system described in U.S. patent application Ser. No. 11/336,499, entitled “Methods and Systems for Assessing Security Risks,” which is herein incorporated by reference in its entirety.

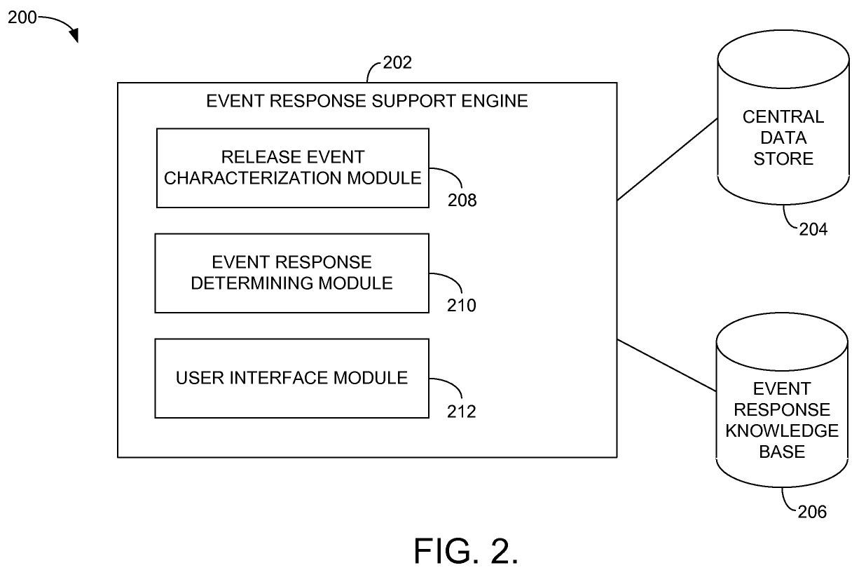

Turning to FIG. 2, a block diagram is provided illustrating an exemplary system 200 for facilitating release event characterization and response determination in accordance with an embodiment of the present invention. As shown in FIG. 2, the system 200 generally includes an event response support engine 202, a central data store 204, and an event response knowledge base 206. The system 200 shown in FIG. 2 is illustrative, and modifications in configuration and implementation will occur to persons skilled in the art. For instance, while the system 200 is shown with only a single event response support engine 202, in embodiments, multiple components may be employed independently or together to characterize hazardous material release events and determine appropriate event responses. Likewise, in various embodiments, more than one central data store 204 and event response knowledge base 206 may be employed. Further, components shown separately within FIG. 2 may be combined in embodiments of the present invention.

The system 200 generally provides efficient access to a wide variety of information relevant to hazardous material release events. In particular, users may employ the system 200 to readily access information, characterize hazardous material release events, and determine appropriate responses to the release events. Because the system 200 provides information and response support in a centralized location, properly tailored responses may be developed in a timely manner.

The event response support engine 202 is generally configured to facilitate responses to the release of hazardous materials. As shown in FIG. 2, the event response support engine 202 may include a release event characterization module 208, an event response determining module 210, and a user interface module 212. Additionally, the event response support engine 202 may be in communication with the central data store 204 and the event response knowledge base 206.

When a hazardous material release event occurs, the release event characterization module 208 may access information from the central data store 204 to characterize the release event. The central data store 204 may be similar to the central data store 102 discussed above with reference to FIG. 1. In particular, the central store 204 may store or otherwise provide access to a variety of information allowing for the characterization of hazardous material release events and determination of appropriate responses.

Based on the characterization of the release event by the release event characterization module 208, the event response determining module 210 may determine an appropriate response to the hazardous material release event. In particular, the event response determining module 210 is configured to communicate with the event response knowledge base 206, which contains information, including rules and rules sets, associated with emergency response procedures for different types of hazardous material releases. The information stored by the event response knowledge base 206 may be based on available literature, best published evidence, and best practices that have been established for emergency response.

The event response support engine 202 further includes a user interface module 212. The user interface module 212 generally provides for interactive event response support events. In particular, users may interact with the system 200 via the user interface module 212. For example, personnel at emergency response centers may employ the user interface module 212 to access information stored in the central data store 204 and/or the event response knowledge base 206. Additionally, the user interface module 212 may allow users to interact with the event characterization module 208 and event response determining module 210.

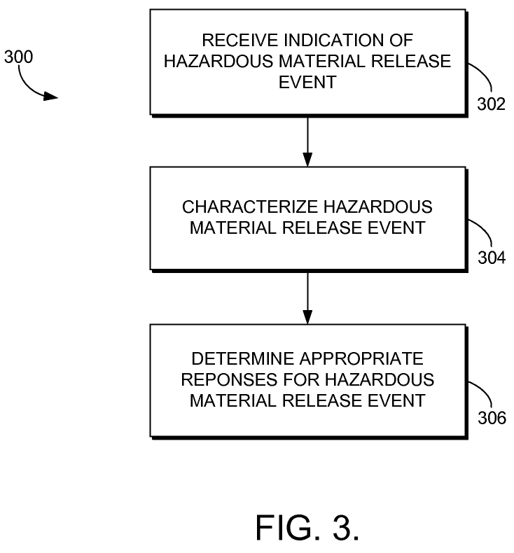

Referring now to FIG. 3, a flow diagram is provided illustrating an exemplary method 300 for characterizing a hazardous material release event and determining a response for the event in accordance with an embodiment of the present invention. The method 300 may be performed, for example, by employing the system 200 described above with reference to FIG. 2. Initially, as shown at block 302, an indication of a hazardous material release event is received by the system. Typically, this includes an indication of a general area in which a hazardous material release event has been reported. For example, an emergency response center may receive information that a train has derailed at a particular location. A user at the emergency response center may access the system and provide an indication regarding where the train derailment has occurred.

In response to the indication of the hazardous material release event, the event is characterized as shown at block 304. In particular, data may be accessed from a central data store, such as the central data store 204 of FIG. 2, to determine characterization information associated with the hazardous material(s) involved, such as the type and volume of hazardous material(s). Additionally, context-sensitive information surrounding the area may be accessed to further characterize the hazardous material release event. For instance, current weather information, such as wind speed and direction, may be employed for plume modeling to determine areas that are at risk of being affected by the release event. Additionally, demographic information may be accessed to identify affected populations.

After characterizing the hazardous material release event, appropriate responses to the event may be determined, as shown at block 306. The system may compare the release event characterization against a knowledge base, such as the event response knowledge base 206 of FIG. 2, to determine recommended responses. For instance, the system may identify emergency personnel required to respond to the event, including required certifications based on the characterized event. Additionally, the system may identify emergency equipment and other resources that may be required. Using available context-sensitive information, the system may identify corridors to shut down to prevent individuals from entering danger zones, provide recommended evacuation areas and routes, and provide routes for emergency personnel to access the area affected by the release event.

In some embodiments of the present invention, the system may automatically characterize a hazardous release event based on an indication of the event, as well as automatically provide recommended response procedures. In other embodiments, a user may interact with the system to characterize a hazardous release event and determine appropriate responses. Any and all such variations are contemplated within the scope of the present invention.

As can be understood, embodiments of the present invention provide methods, systems, and user interfaces allowing efficient access to information relevant to hazardous material release events. Additionally, embodiments of the present invention provide methods, systems, and user interfaces that facilitate the characterization of hazardous material release events and determination of appropriate responses. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

What is claimed is:

1. A computerized method for facilitating a response to an event involving a release of one or more hazardous materials, the method comprising:
receiving an indication of a hazardous material release event, the indication including information associated with a location of the hazardous material release event;
characterizing the hazardous material release event by comparing the information associated with the location of the hazardous material release event with information associated with the transportation of hazardous materials;
determining an event response based on the characterized hazardous material release event; and
presenting information associated with the event response to a user.

2. The method of claim 1, wherein the hazardous material release event comprises at least one of an accident, a natural disaster, and a terrorist activity that causes the release of one or more hazardous materials.

3. The method of claim 1, wherein at least one of the one or more hazardous materials is a toxic inhalation hazard chemical.

4. The method of claim 1, wherein characterizing the hazardous material release event comprises identifying at least a portion of the one or more hazardous materials that have been released.

5. The method of claim 1, wherein characterizing the hazardous material release event comprises determining an area affected by the hazardous material release event.

6. The method of claim 1, wherein determining an event response comprises comparing the characterized hazardous release event against a knowledge base, the knowledge base including information associated with recommended response procedures for different types of hazardous material release events.

7. The method of claim 1, wherein determining an event response comprises at lease one of: determining emergency personnel to respond to the hazardous material release event; determining resources for the event response; determining evacuation requirements for the hazardous material release event; determining corridors to shut down; and determining at least one route for emergency personnel to access the hazardous material release event.

8. The method of claim 1, wherein the method further comprises presenting information associated with the characterized hazardous material release event to a user.

9. A computerized system for facilitating response to an event associated with a release of one or more hazardous materials, the computerized system comprising one or more computing devices having one or more computer-readable media with computer-program modules embodied thereon, the computer-program modules comprising:
a release event characterization module that characterizes an event associated with the release of one or more hazardous materials; and
an event response determining module that determines an event response based on the characterized event.

10. The computerized system of claim 9, wherein the release event characterization module characterizes the event by determining at least a portion of the one or more hazardous materials released by the event.

11. The computerized system of claim 9, wherein the release event characterization module accesses a data store to characterize the event, the data store storing or providing access to information associated with the transportation of hazardous materials.

12. The computerized system of claim 10, wherein the release event characterization module receives an indication of the event and characterizes the event based on the indication of the event and information accessed from the data store.

13. The computerized system of claim 11, wherein the indication of the event includes information associated with a location of the event.

14. The computerized system of claim 9, wherein the event response determining module accesses a knowledge base to determine an event response, the knowledge base including information associated with recommended response procedures for different types of hazardous material release events.

15. The computerized system of claim 9, wherein the computer-program modules further comprise a user interface module that facilitates user interaction with at least one of the release event characterization module and the event response determining module.

16. One or more computer-readable media having computer-useable instructions embodied thereon, the computer-useable instructions for performing a method for facilitating a response to an event associated with a release of one or more hazardous materials, the method comprising:
receiving an indication of a hazardous material release event;
characterizing the hazardous material release event;
determining an event response based on the characterized hazardous material release event; and
presenting information associated with the event response to a user.

17. The one or more computer-readable media of claim 15, wherein receiving an indication of the hazardous material release event comprises receiving information associated with a location of the hazardous material release event.

18. The one or more computer-readable media of claim 16, wherein characterizing the hazardous material release event comprises comparing the information associated with the location of the hazardous material release event with information associated with the transportation of hazardous materials.

19. The one or more computer-readable media of claim 15, wherein determining an event response comprises comparing the characterized hazardous material release event against a knowledge base, the knowledge base including information associated with recommended response procedures for different types of hazardous material release events.

20. The one or more computer-readable media of claim 15, wherein the method further comprises presenting information associated with the characterized hazardous material release event to a user.
